(19) United States
(12) Patent Application Publication
(10) Pub. No.: US 2014/0085936 A1
(43) Pub. Date: Mar. 27, 2014

(54) VARIABLE FREQUENCY CONVERTER AND ADJUSTING METHOD FOR THE SAME

(71) Applicant: DELTA ELECTRONICS (SHANGHAI) CO., LTD., Shanghai (CN)

(72) Inventors: Hongyuan Jin, Shanghai (CN); Tao Ge, Shanghai (CN); Peiqing Hu, Shanghai (CN); Jinping Zhou, Shanghai (CN); Hongjian Gan, Shanghai (CN); Jianping Ying, Shanghai (CN)

(73) Assignee: DELTA ELECTRONICS (SHANGHAI) CO., LTD., Shanghai (CN)

(21) Appl. No.: 13/626,384

(22) Filed: Sep. 25, 2012

(51) Int. Cl. H02M 3/335

(52) U.S. Cl. 363/16

(57) ABSTRACT

A variable frequency converter and an adjusting method for the same are provided in the present application. The variable frequency converter operates in a variable frequency mode, and comprises a power stage circuit module and a variable frequency signal stage circuit module which are connected to form a closed-loop circuit system. The variable frequency converter further comprises an adjusting unit outputting a continuous interfering signal and loading the continuous interfering signal into the variable frequency signal stage circuit module so as to cause operating frequency of the power stage circuit module controlled by the variable frequency signal stage circuit module to change continuously. In the present application, in the variable frequency converter, the EMI peak value is decreased.

### CROSS-REFERENCE TO RELATED APPLICATIONS

This non-provisional application claims priority under 35 U.S.C. §119(a) on Patent Application No. 201210134931.1 filed in P.R. China on May 3, 2012, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present application relates to a switch power field, and more specifically to a variable frequency converter and an adjusting method for the same.

### BACKGROUND

A switch power converter is widely applied in energy conversion field due to advantages, such as high efficiency, saving energy, and so on. It can be found in various fields, such as a charger in a mobile electronic product (such as a mobile phone, a MP3, and so on), a power supply in a household electrical appliance (such as a TV set, a refrigerator), vehicle electronics, base station communication, new energy technology, military aerospace technology, and so on.

EMI (Electro Magnetic Interference) is a kind of interference more common in an electronic circuit. Whether it is in switch power or in integrated circuit or other electronic fields, how to effectively decrease EMI is a problem which should be considered in designing a circuit or a system by an electronic designer.

According to different modes of operating frequencies, switch power converters may be classified into two types: one type is a constant frequency converter, and the other type is a variable frequency converter. The two types of the converters, as shown in FIG. 1 and FIG. 2, comprise two parts: the constant frequency converter comprising a power stage circuit module 101 and a constant frequency signal stage circuit module 102; and the variable frequency converter comprising a power stage circuit module 101 and a variable frequency signal stage circuit module 202.

As shown in FIG. 1 and FIG. 2, the power stage circuit module 101 and the constant frequency signal stage circuit module 102 or the power stage circuit module 101 and the variable frequency signal stage circuit module 202 forms a closed-loop system. As shown in FIG. 3, G(S) is a transfer function of the power stage circuit module, and H(S) is a transfer function of the constant frequency signal stage circuit module 102 or the variable frequency signal stage circuit module 202. R(S) signal is transferred to C(S) signal via the transfer function G(S). As shown in FIG. 1 and FIG. 2, for the constant frequency converter and the variable frequency converter, the power stage circuit modules 101 of both of them may be same, but the constant frequency signal stage circuit module 102 may have difference from the variable frequency signal stage circuit module 202. Referring to FIG. 4, a constant frequency converter is illustrated, a constant frequency signal stage circuit module 102 of the constant frequency converter generally comprises a oscillator 105 capable of generating a constant frequency signal, an oscillation frequency of the oscillator is an operating frequency of the close-loop system which is determined by oscillation of Rt and Ct. Since the operating frequency of the close-loop system of the constant frequency converter is constant, it is easy to realize frequency jitter in the constant frequency converter by changing effective values of Rt and Ct, so as to diminish EMI. In the constant frequency converter, as long as the oscillator yields jitter, frequency jitter can be realized. In other traditional constant frequency converter, there are many other ways to realize frequency jitter, which are not fully illustrated one by one herein.

However, the variable frequency signal stage circuit module 202 of the variable frequency converter generally does not comprise an oscillator as shown in FIG. 4. An operating frequency of the variable frequency converter is determined by an input-output state thereof. Taking a topology of a flyback converter shown in FIG. 5 as an example, difference between the variable frequency converter and the constant frequency converter will be further described. A signal stage circuit module part of the flyback converter is not shown in FIG. 5, and FIG. 5 mainly schematically illustrates a power stage circuit module. The flyback converter as shown in FIG. 5 may not only operate in a mode of constant frequency, for example CCM (current continuous mode); but also operate in a variable frequency mode, for example DCMB (current critical mode). A current of the flyback converter operating in the DCMB mode is shown in FIG. 6. Therefore, as can be seen from the switch power converters illustrated as above, the same power circuit module may not only operate in the mode of constant frequency, but also operate in the mode of variable frequency, but hardware or control method of the constant frequency signal stage circuit module may be different from hardware or control method of the variable frequency signal stage circuit module. Still taking the topology of the flyback converter shown in FIG. 5 as an example, referring to FIG. 7, an operating frequency of the flyback converter will change with change in load (i.e. an output of the flyback converter) when the flyback converter operates in the mode of variable frequency, an operating frequency of the flyback converter is constant and will be not affected by change in load (i.e. will not change as an output changes) when the flyback converter operates in the mode of constant frequency. Therefore, in some circumstances, the variable frequency converter may not distinguished from the constant frequency only by the topologies of the power stage circuit module, but may by the signal stage circuit module or control method.

Similarly to the constant frequency converter, the variable frequency converter also has a problem of EMI, an operating frequency of the variable frequency converter will change with change in input or/and output, it is relatively complicated to control the variable frequency converter, and it is relatively difficult to add a frequency jitter to the variable frequency converter. A conventional method is to set an EMI filter at input of variable frequency converter so as to reduce EMI. This not only increases cost, but also causes a large volume of the variable frequency converter.

Although the variable frequency converter with EMI filter has a high efficiency and is widely applied in some middle or lower power switch power systems, EMI is still worse according to certain EMI regulation. Keeping EMI in variable frequency converter as much less as possible is a desired target to be accomplished by the industry.

### SUMMARY OF THE INVENTION

It is therefore an object of present application to provide a variable frequency (VF) converter, and this converter realizes frequency jitter to extend its operating frequency range so as to reduce the EMI or EMI peak value in the VF converter. The VF converter may reduce the EMI or relatively save the cost by comparing with the conventional VF converter.

A first aspect of the present application discloses a VF converter. The VF converter comprises a power stage circuit module and a variable frequency signal stage circuit module which are connected each other to form a closed-loop circuit system. The VF converter further comprises an adjusting unit outputting a continuous interfering signal and loading the continuous interfering signal into the variable frequency signal stage circuit module so as to extend operating frequency range of the VF converter.

A frequency of the continuous interfering signal is higher than a crossover frequency of the closed-loop circuit system, so that it realizes continuous jitter on the signal loaded into the variable frequency signal stage circuit module and continuous change of the operating frequency of the power stage circuit module.

A second aspect of the present application discloses a VF converter comprising a power stage circuit module and a variable frequency signal stage circuit module which are connected each other to form a closed-loop circuit system. The VF converter further comprises an adjusting unit accessed to the power stage circuit module, and the adjusting unit may change a resonance parameter of the power stage circuit module so as to cause an operating frequency of the power stage circuit module to change continuously.

A third aspect of the present application discloses an adjusting method for a VF converter, the VF converter comprises a power stage circuit module and a variable frequency signal stage circuit module which are connected each other to form a closed-loop circuit system. The adjusting method comprises: providing an adjusting unit to the VF converter, loading a continuous interfering signal into a signal inputted to the power stage circuit module by the variable frequency signal stage circuit module by means of the adjusting unit, so as to cause an output signal of the VF converter to jitter and expand an operating frequency range of the VF converter.

Technical effects of the present application are as follows: in the VF converter, the EMI may be lowered, and EMI filter may be effectively reduced or avoided from using. In the VF converter, the frequency jitter may be realized, the EMI energy may be averaged, and a jitter peak value of the EMI may be lowered.

### BRIEF DESCRIPTION OF THE DRAWINGS

FIG. 1 and FIG. 4 are schematic diagrams of constant frequency mode converters;

FIG. 2, FIG. 8, FIG. 9, FIG. 11, FIG. 12, and FIG. 23 are schematic diagrams of VF converters;

FIG. 3 is a self-control schematic diagram of a switch power converter;

FIG. 5, FIG. 13, FIG. 16, FIG. 17, and FIG. 20 are topologies of flyback VF converters;

FIG. 6 is a current-time relationship plot of the flyback converter operating in a DCMB mode;

FIG. 7 is a schematic diagram illustrating a relationship between an operating frequency and a load of the constant frequency mode converter and the VF converter;

FIG. 10 is a Bode plot of a closed-loop circuit system shown in FIG. 3;

FIG. 14 is a schematic diagram of a VF converter which topology is BUCK;

FIG. 15 is a schematic diagram of a VF converter which topology is BOOST;

FIG. 18 is a schematic diagram of the VF converter which topology is BUCK;

FIG. 19 is a schematic diagram of the VF converter which topology is BOOST;

FIG. 21 is an EMI conduction test diagram of the VF converter in FIG. 17 without a jitter signal generator;

FIG. 22 is an EMI conduction test diagram of the VF converter in the technical solution shown in FIG. 17 with a jitter signal generator which is a sinusoidal waveform generator circuit;

FIG. 24, FIG. 25, and FIG. 26 are topologies of flyback VF converters;

FIG. 27 is a schematic diagram illustrating an effect of a variable resistor module on a turn-on time of the converter;

FIG. 28 and FIG. 29 are schematic diagrams of VF converters;

FIG. 30 and FIG. 31 are schematic diagrams of quasi-resonant flyback converter;

FIG. 32 is a schematic diagram illustrating a drain-source voltage waveform for the quasi-resonant flyback converter;

FIG. 33 is a schematic diagram illustrating a LLC resonant topology as one embodiment of VF converter;

FIG. 34 is a schematic diagram illustrating a LLC resonant converter with PFM control;

FIG. 35 is a schematic diagram of an adjusting unit;

FIG. 36 is a schematic diagram illustrating a quasi-resonant buck converter; and

FIG. 37 is a schematic diagram illustrating a quasi-resonant boost converter.

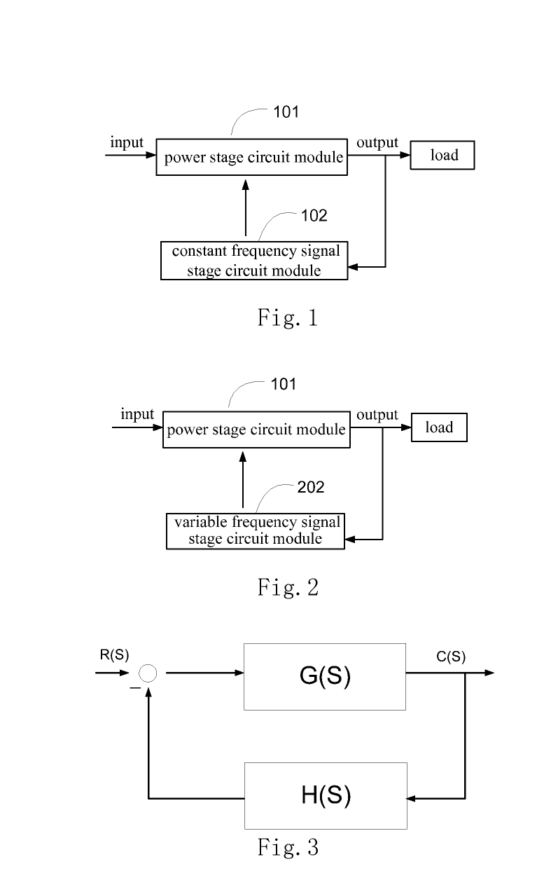

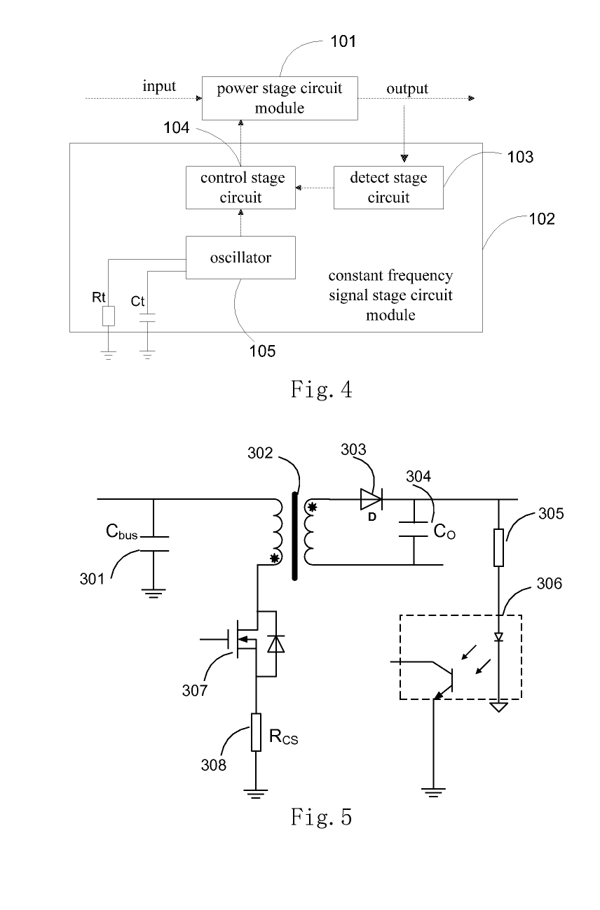

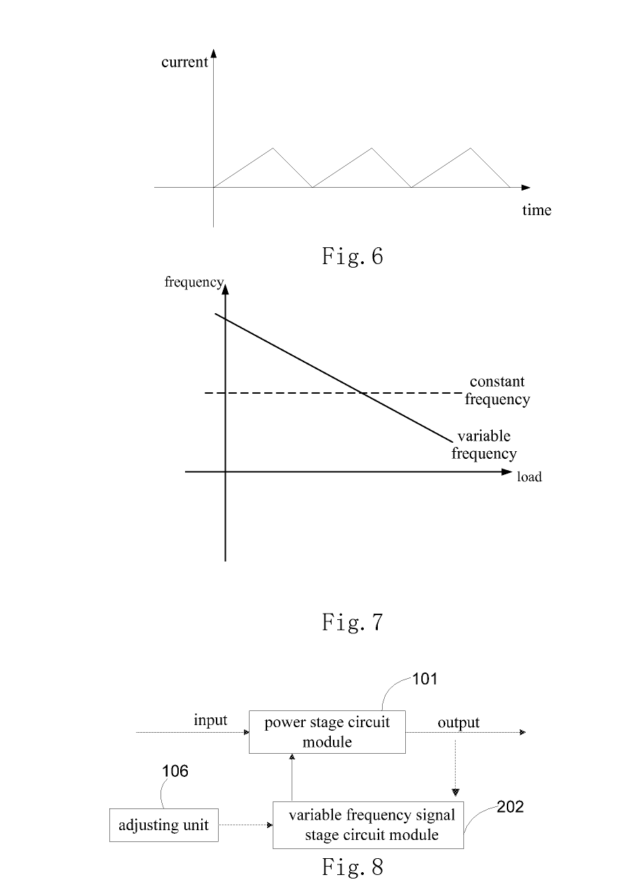

### DESCRIPTION OF THE PREFERRED EMBODIMENTS

Hereinafter, specific embodiments of the present application will be presented and described in details accompanied by the drawings.

In order to effectively diminish EMI or avoid using an EMI filter, one object of the present application is to realize frequency jitter in a VF converter to extend the operating frequency range of the VF converter, so that EMI in the variable frequency converter is distributed in more wider frequency band and EMI peak value can be suppressed comparing with the EMI in the conventional VF converter.

At a case that an input-output state is constant, an operating frequency of the variable frequency converter is relatively stable, a peak value of the EMI herein is relatively high at the switching frequency and its multiples. The present application actively loads a continuous interfering signal into the variable frequency converter so as to cause the operating frequency of the variable frequency converter to change continuously, so that the EMI peak value can be reduced. At the same time, the continuous interfering signal is required to overcome its attenuation caused by the VF converter in which the continuous interfering signal is loaded, so as to lead that operating frequency of the VF converter has wider frequency range while the input-output of variable converter is relatively stable. The VF converter of the present application will be described by taking a DC-DC power source converter as an example.

The present application discloses the variable frequency converters from two aspects. A VF converter disclosed by a first aspect is by providing an adjusting unit outputting a continuous interfering signal and loading the continuous interfering signal into a variable frequency signal stage circuit module of the VF converter so as to cause an operating frequency of a power stage circuit module controlled by the variable frequency signal stage circuit module to change continuously. A VF converter disclosed by a second aspect is by providing an adjusting unit to a power stage circuit module of the VF converter so as to change a resonance parameter of the power stage circuit module and thus to cause an operating frequency of the power stage circuit module to change continuously. FIG. 8 illustrates a schematic diagram of a VF converter corresponding to the VF converter disclosed from the first aspect. FIG. 9 illustrates a schematic diagram of a VF converter corresponding to the VF converter disclosed from the second aspect. By loading the continuous interfering signals respectively into different modules of the VF converters disclosed by the two aspects, the parameters related to operating frequencies of VF converters could be changed, so as to realize continuous frequency jitter of the operating frequencies.

The VF converter disclosed by the first aspect has the following requirement on the continuous interfering signal outputted by the adjusting unit: the jitter signal is not an instantaneous jitter, since the VF converter is a closed-loop circuit system, the instantaneous jitter signal cannot realize that operating frequency of the power stage circuit module changes continuously. Moreover, if a frequency of the continuous interfering signal is lower than a crossover frequency of the closed-loop circuit system, the jitter signal is also easily attenuated by the closed-loop circuit system itself. Therefore the frequency of the continuous interfering signal outputted by the adjusting unit should be higher than the crossover frequency of the closed-loop circuit system, so as to make the operating frequency of the power stage circuit module change continuously. The continuous interfering signal is a voltage waveform or a current waveform which is periodic or non-periodic and whose amplitude may be constant or variable. It should be noted that, when the input-output of the VF converter is relatively stable, the continuously changing frequency jitter signal would meanwhile cause the output of the VF converter to fluctuate in a certain range. In order to address this fluctuation, a designer may adjust the amplitude of the continuous interfering signal according to requirement on the output range of the VF converter, so as to make the fluctuation of the output of the VF converter stay in an acceptable range.

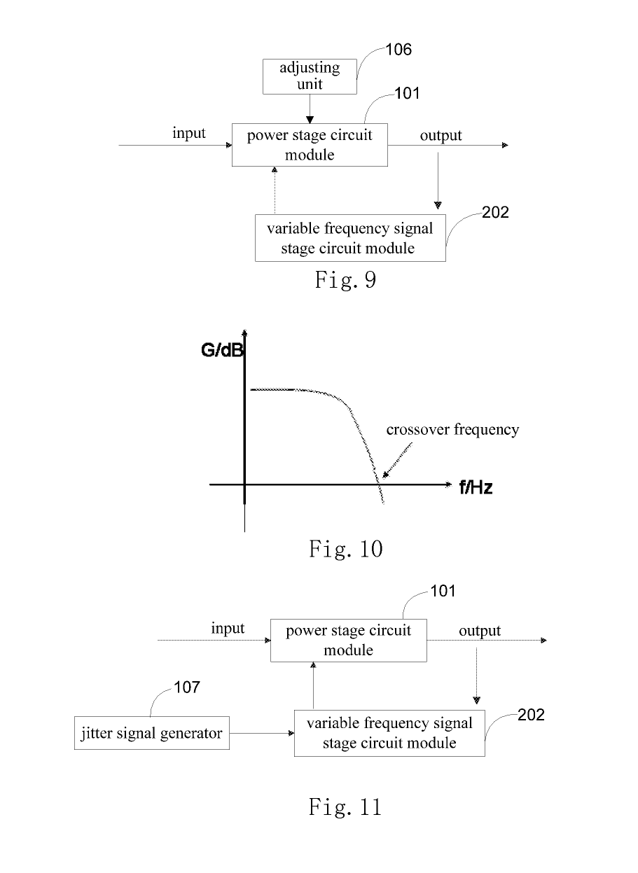

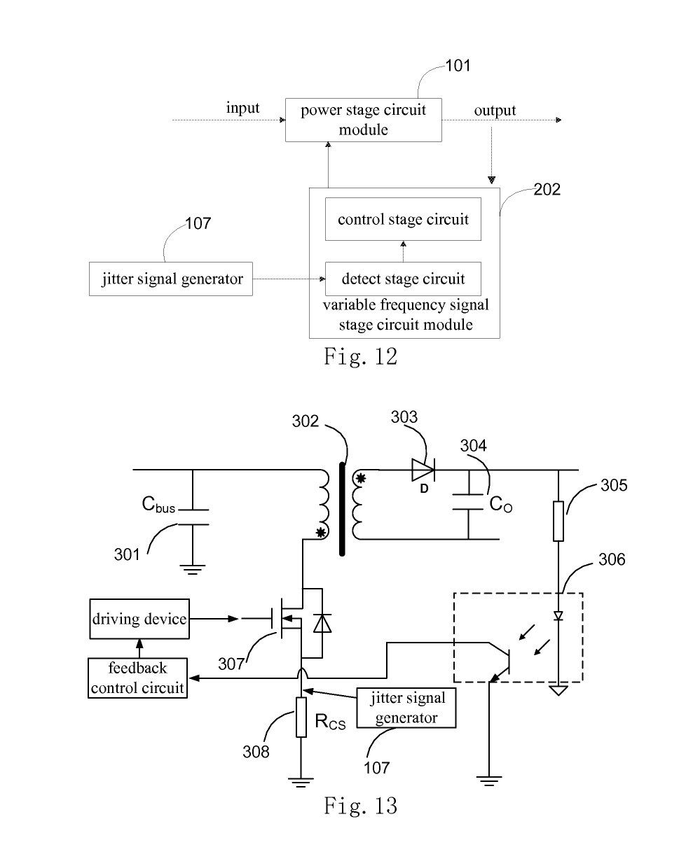

For an equivalent close-loop system of the VF converter as shown in FIG. 3, a definition of a crossover frequency will be simply explained accompanied by Bode chart as shown in FIG. 10. R(s) and C(s) are respectively referred as an input and an output of the system as shown in FIG. 3. G(s) is a transfer function of the main circuit. H(s) is a transfer function of feedback control circuit. In a closed-loop system composed of G(s) and H(s), a product of G(S) and H(S) represents a transfer function of an open-loop system. A frequency in correspondence to a gain which is 1 (or 0 dB) in the Bode chart of the open-loop transfer function G(S)H(S) is referred to as the crossover frequency. A phase corresponding to the crossover frequency in the phase frequency plot reflects a relative stability of the closed-loop system. An intersection point between the plot and the transversal coordinate in FIG. 10 namely is the crossover frequency point.

Hereinafter, embodiments of the VF converter disclosed in the first aspect will be described in details.

### Embodiment 1

In the VF converter, if a control signal in the variable frequency signal stage circuit module is continuously changed; operating frequency of the power stage circuit module may be caused to change continuously. If the frequency of continuous interfering signal is higher than a crossover frequency of a VF converter, the continuous interfering signal loaded into the variable frequency signal stage circuit module could make operating frequency of the power stage circuit module change continuously, thereby causing the operating frequency of the VF converter to jitter.

In FIG. 11, a schematic diagram of the VF converter is illustrated. Wherein, an adjusting unit is implemented by a jitter signal generator 107. The jitter signal generator 107 outputs a continuous interfering signal to the variable frequency signal stage circuit module 202. The jitter signal generator 107 may be a signal generator commonly used in the prior art. The continuous interfering signal is loaded into the variable frequency signal stage circuit module 202. The jitter signal generator 107 changes the control signal of the variable frequency signal stage circuit module 202 transferred to the power stage circuit module 101 by means of generating the continuous interfering signal, so as to realize jitter on the operating frequency of the VF converter. Wherein, the frequency of continuous interfering signal is higher than a crossover frequency of the equivalent closed-loop circuit system of the VF converter. The jitter signal generator 107 may be arranged in any position in the power stage circuit module or the variable frequency signal stage circuit module.

### Embodiment 2

On a basis of the technical solution of FIG. 11, more specifically, the present application discloses another embodiment with reference to FIG. 12.

The variable frequency signal stage circuit module 202 comprises a detection stage circuit and a control stage circuit. Taking a topological graph of a flyback VF converter shown in FIG. 13 as an example, wherein, a power stage circuit module 101 comprises an electrolytic capacitor C_{bus} 301, a transformer 302, a rectifier diode D303, an output electrolytic capacitor C₀ 304, and a power switch 307. The detection stage circuit comprises a detecting resistor R_{cs} 308, a resistor 305, and an optocoupler 306. The detecting resistor R_{cs} 308 is used for detecting sampling current. Wherein, the detecting resistor R_{cs} 308 belongs to an input detection stage circuit, the resistor 305 and the optocoupler 306 belong to an output detection stage circuit, and the output detection stage circuit detects output of the power stage circuit module 101. The control stage circuit comprises a driving apparatus and a feedback control circuit. The feedback control circuit receives a signal outputted by the optocoupler 306 and output a feedback signal to the driving apparatus, and the driving apparatus outputs a control signal to the power stage circuit module. Output signal of the jitter signal generator 107 is loaded into the detection stage circuit, for example the input detection stage circuit. Specifically, topologies of three circuits are shown in FIGS. 13-15, output of the jitter signal generator 107 is connected to a terminal of the detecting resistor Rcs 308, so that a continuous interfering signal generated by the jitter signal generator 107 is loaded into the sampling current of the input detection stage circuit, so that the magnitude of the sampling current of the input detection stage circuit is changed, thereby causing the signal inputted into the control stage circuit by the input detection stage circuit to jitter continuously and realizing an effect on the operating frequency of the power stage circuit module 101.

In the circuit topology of the flyback VF converter shown in FIG. 13. The continuous interfering signal generated by the jitter signal generator 107 comprises a voltage waveform or current waveform which amplitude is constant or variable. The wave is periodic or non-periodic. The wave could be a sinusoidal wave, a triangular wave, a rectangular wave, a trapezoidal wave or a superimposed wave with various waveforms, and so on. The continuous interfering signal is indirectly or directly loaded into a signal detected by the input detection stage circuit (for example the sampling current signal) via an adder, a multiplier, an amplifier, and so on, so as to cause detection signal output by the input detection stage circuit to change continuously.

As can be appreciated by the person skill in the art, a turn-on time of the power switch 307 of the VF converter determines its operating frequency. When the jitter signal generator is not provided, the power switch 307 turns off until the detection signal reaches to a preset value. When the jitter signal generator is provided, when the loaded continuous interfering signal causes the detection signal to be decreased, the power switch 307 of the VF converter will be maintained to turn on, and will turn off until reaching an original magnitude of the detection signal. This causes a driving cycle of the VF converter to be increased and a driving frequency of the VF converter to be decreased, the operating frequency of the VF converter is also correspondingly decreased. When the loaded continuous interfering signal causes the detection signal to be increased, the operating frequency of the VF converter is also increased.

The amplitude of the continuous interfering signal determines magnitude of change in the detection signal so as to cause an effect on the operating frequency. At the same time, when the frequency of the continuous interfering signal is higher than a crossover frequency of the equivalent closed-loop circuit system of the VF converter, the loaded continuous interfering signal will not be attenuated by the closed-loop circuit system of the VF converter itself, so that the operating frequency of the VF converter occurs to change continuously, thereby realizing continuous jitter on the operating frequency of the VF converter.

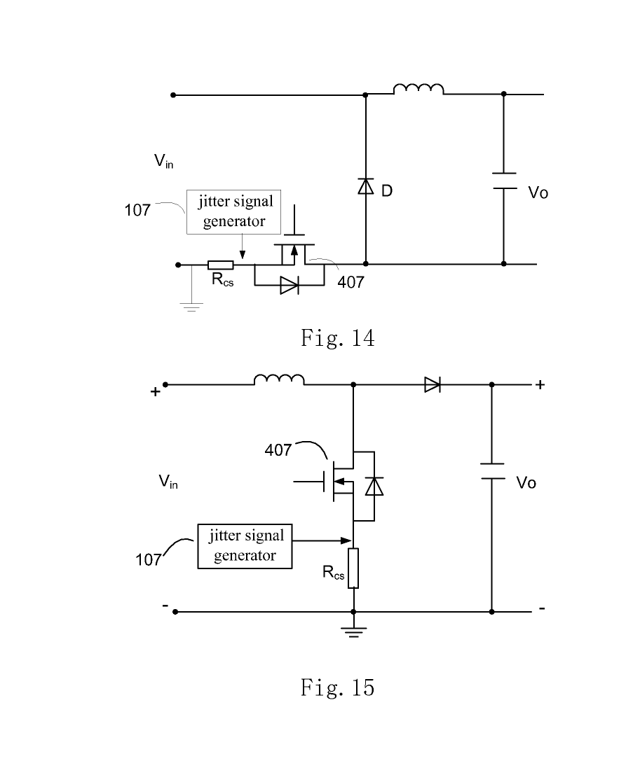

The method to realize frequency jitter by changing magnitude of the detection signal (for example, a magnitude of a sampling current) is similarly applicable to a buck or boost VF converter. Referring to FIG. 14 and FIG. 15 which are respective schematic diagrams of buck and boost VF converters, the part of the variable frequency signal stage circuit modules are not illustrated in FIG. 14 and FIG. 15.

Rcs in FIG. 14 and FIG. 15 is a detecting resistor, the output of jitter signal generator 107 is connected to a terminal of the detecting resistor, a continuous interfering signal generated by the jitter signal generator 107 is loaded into a sampling current detected by detecting resistor Rcs, thereby affecting a turn-on time of the power switch 407 and affecting the operating frequency of the VF converter.

### Embodiment 3

Similar to FIG. 13, referring to FIG. 16, the present application further discloses another embodiment. FIG. 13 directly changes magnitude of the sampling current detected by input detection stage circuit so as to realize continuous jitter on the operating frequency. FIG. 16 illustrates an embodiment of the present application that a continuous interfering signal generated by an adjusting unit is loaded into an output detection stage circuit. Specifically, in the embodiment illustrated in FIG. 16, the embodiment, that magnitude of a voltage detection signal in an output detection stage circuit is changed so as to realize jitter of the operating frequency on the VF converter, is illustrated.

The variable frequency signal stage circuit module comprises a detection stage circuit and a control stage circuit. Wherein, a power stage circuit module comprises an electrolytic capacitor C_{bus} 301, a transformer 302, a rectifier diode D 303, an output electrolytic capacitor C₀ 304, and a power switch 307. A detection stage circuit comprises a detecting resistor R_{cs} 308, a resistor 305, and an optocoupler 306. The resistor 305 is used for sampling voltage output by the VF converter. Wherein, the detecting resistor R_{cs} 308 belongs to an input detection stage circuit, the resistor 305 and the optocoupler 306 belong to an output detection stage circuit. The input detection stage circuit and the output detection stage circuit respectively detect an input and an output of the power stage circuit module and output a signal to the control stage circuit. The control stage circuit comprises a driving apparatus and a feedback control circuit. The feedback control circuit receives a signal of the optocoupler 306 and outputs a feedback signal to the driving apparatus; the driving apparatus outputs a control signal to the power stage circuit module. In the present embodiment, an adjusting unit is a jitter signal generator 107. An output signal of the jitter signal generator 107 is loaded into the detection stage circuit, specifically loaded into the output detection stage circuit, so that cause a signal jitter of the control stage circuit by changing the signal of the output detection stage circuit continuously. Specifically, the output signal of the jitter signal generator 107 is loaded into a terminal of the resistor 305, so as to affect the sampling voltage at the resistor 305 detected by the output detection stage circuit.

In a circuit topology of the flyback VF converter shown in FIG. 16, the continuous interfering signal generated by the jitter signal generator 107 comprises a voltage waveform or a current waveform whose amplitude is constant or variable. The waveform is periodic or non-periodic, and the waveform could be a sinusoidal waveform, a triangular waveform, a rectangular waveform, a trapezoidal waveform or a superimposed waveform with various waveforms, and so on. The continuous interfering signal is indirectly or directly loaded into the output detection stage circuit through an adder, a multiplier, or an amplifier, so as to cause magnitude of the detection signal outputted by the output detection stage circuit to change, for example, loading through an adder, i.e. the continuous interfering signal are superimposed on the voltage detection signal.

The voltage detection signal with continuous interfering signal is transmitted to the optocoupler 306, and then transmitted to the feedback control circuit through the optocoupler, so as to affect the feedback signal outputted by the feedback control circuit. The feedback signal affects control signal outputted by the driving apparatus so that turn-on time of the switch in the power stage circuit module will be changed, and so is the operating frequency of the VF converter.

If the continuous interfering signal causes the voltage detection signal to increase, the turn-on time of the power switch will increase; thereby causing a driving cycle to be increased, but driving frequency or the operating frequency of the VF converter is correspondingly decreased. Accordingly, if the continuous interfering signal causes the voltage detection signal to decrease, the driving cycle will be decreased, and the operating frequency of the VF converter will be increased. Amplitude of the continuous interfering signal generated by the jitter signal generator determines magnitude of change in the voltage detection signal, and affects the operating frequency. When a frequency of the continuous interfering signal is higher than a crossover frequency of the VF converter, the voltage detection signal may be caused to change continuously, so as to cause the operating frequency of the VF converter to change continuously, thereby realizing continuous jitter on the operating frequency.

The way that the adjusting unit 106 with the jitter signal generator is connected to the output detection stage circuit is similarly applicable to an output detection stage circuit of a buck or boost VF converter, or other kind of VF converter.

### Embodiment 4

An adjusting unit 106 may be arranged in the control stage circuit.

FIG. 17 is a circuit topology of a flyback VF converter. A basic structure thereof is similar to those in FIG. 13 and FIG. 16, the control stage circuit comprises a driving apparatus and a feedback control circuit, the difference lies in that a continuous interfering signal generated by a jitter signal generator 107 is indirectly or directly loaded into a feedback signal outputted by the feedback control circuit via an adder, a multiplier or an amplifier, and so on, so as to cause the feedback signal to change. The continuous interfering signal could be a sinusoidal waveform, a triangular waveform, a rectangular waveform, a trapezoidal waveform or a superimposed waveform with various waveforms. Amplitude of the continuous interfering signal is constant or variable; the continuous interfering signal may be a voltage waveform or a current waveform which changes periodically or non-periodically. The amplitude of the continuous interfering signal determines magnitude of change in the feedback signal, and affects the control signal outputted by the driving apparatus. The control signal is transmitted to the power stage circuit module, so as to cause operating frequency of the power stage circuit module to change. Loading the continuous interfering signal, the operating frequency of the power stage circuit module may change continuously, thereby realizing continuous jitter on the operating frequency of the VF converter.

A frequency of an output signal of the jitter signal generator should be higher than the crossover frequency of the whole closed-loop circuit system of the VF converter, so as to realize the continuous jitter on the operating frequency of the VF converter. The amplitude of the waveform of the continuous interfering signal determines the magnitude of change in the feedback signal, and then affects the magnitude of change in the operating frequency. If the feedback signal changes continuously, it will cause the continuous jitter on the operating frequency of the VF converter, thereby realizing the continuous jitter on the operating frequency.

In fact, the adjusting unit 106 may be arranged in any position in the control stage circuit, i.e., the continuous interfering signal may be not only loaded into the feedback signal, but also loaded into other signals existed in the control stage circuit.

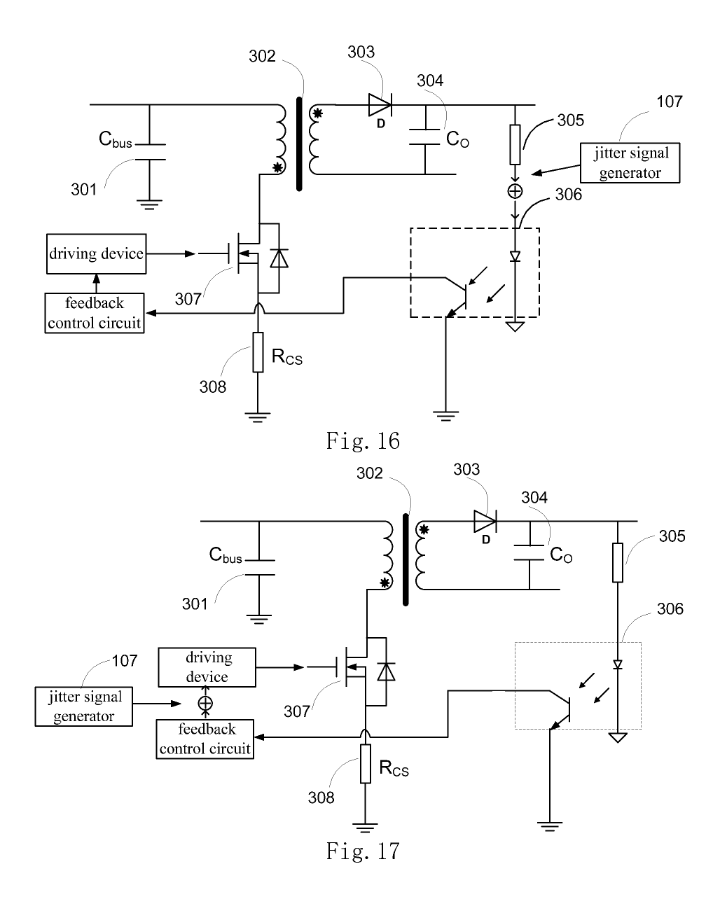

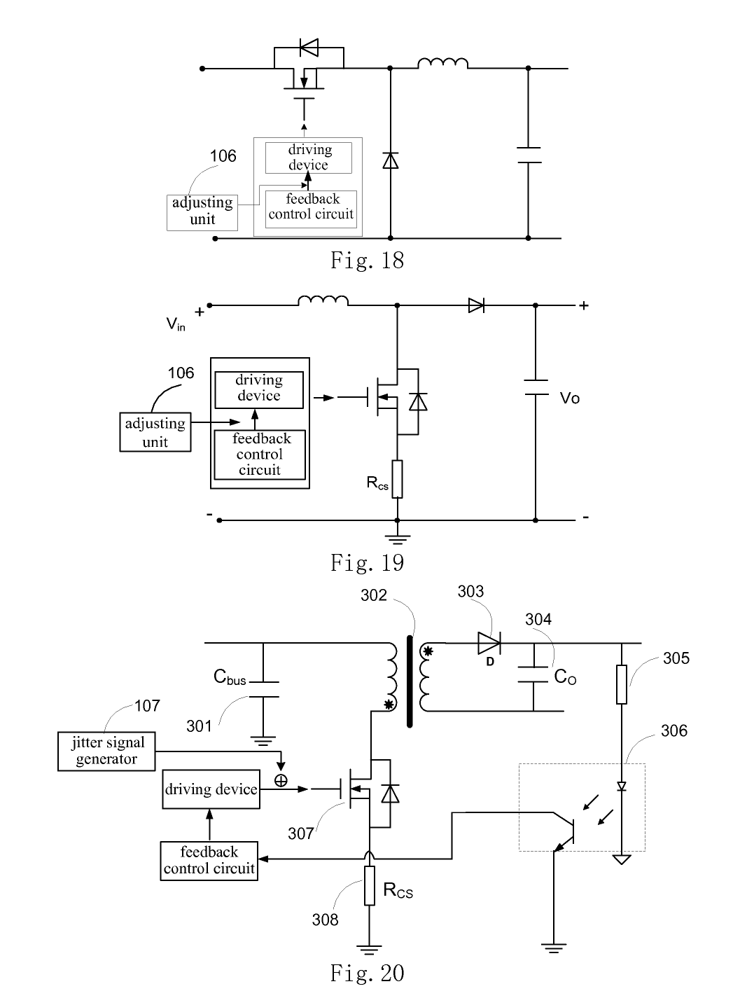

The method to load the continuous interfering signal generated by the adjusting unit 106 into a signal outputted by the feedback control circuit to the driving apparatus in the control stage circuit so as to realize frequency jitter is similarly applicable to a buck or boost VF converter, as respectively shown in FIG. 18 and FIG. 19. In FIG. 18 and FIG. 19, signal stage circuit module parts are not shown.

The continuous interfering signal generated by the adjusting unit 106 may be also loaded into a control signal outputted by the control stage circuit to the power stage circuit module, for example, as shown in FIG. 20. The continuous interfering signal outputted by the jitter signal generator 107 may be loaded into a signal outputted by the driving apparatus to control power switch 307 in the power stage circuit module. This may be similarly applicable to a topology of buck or boost VF converter or other kind of topologies VF converter.

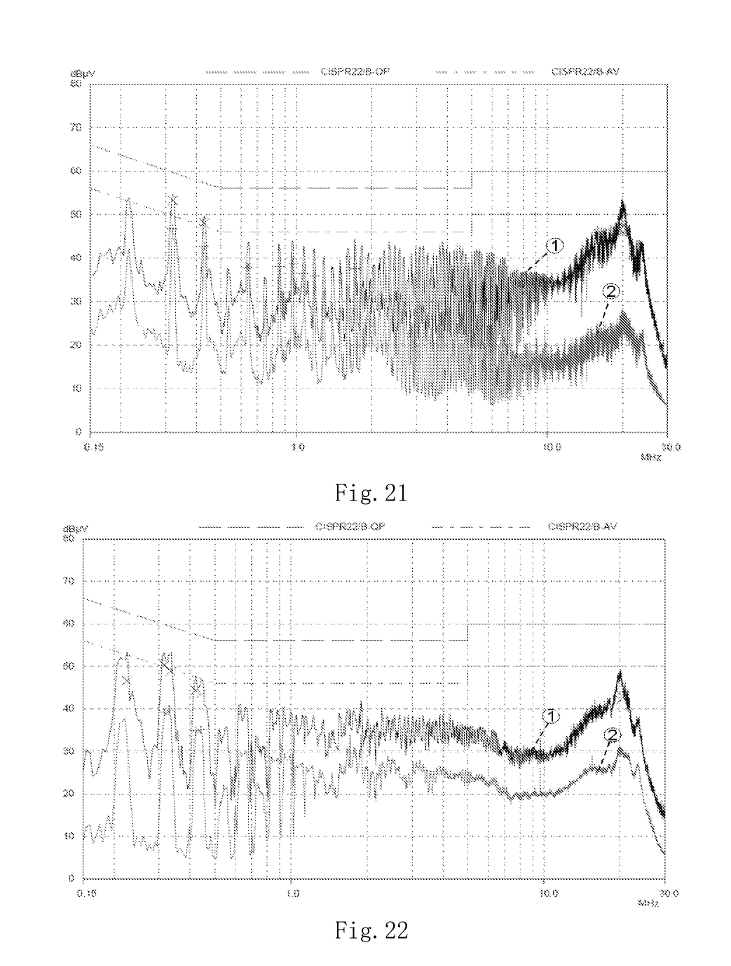

FIG. 21 is an EMI conduction test graph based on the VF converter in FIG. 17 without the jitter signal generator 107. There are two parallel regular lines, an upper line is an upper limit of an EMI quasi-peak value, and a lower line is an upper limit of an EMI average value. The symbol “x” represents a quasi-peak value at a certain frequency point, a symbol“+” represents an average value at a certain frequency point. The larger the value indicated by the longitudinal coordinate is, the poorer the EMI is. Considering that there is a difference among the same type of VF converters, in order to prevent EMI of the VF converters from exceeding the upper limit due to the normal difference, it is generally required that the quasi-peak value and the average value have certain margin to their respective upper limits thereof.

Line \textcircled{1} is a peak value line, a quasi-peak value at a certain frequency may be obtained by calculation; Line \textcircled{2} is an EMI average value line. As can be seen from FIG. 21, the operating frequency of the closed-loop circuit system is constant and about 110 kHz, and EMI energy at multiples of operating frequency is quite high. At 330 kHz and 440 kHz, a frequency band of the average value line is narrower, but the peak value is quite sharp, there is only about 3 dB-4 dB margin to the upper limit.

FIG. 22 is an EMI conduction test graph based on the VF converter in FIG. 17 with the jitter signal generator 107. The jitter signal generator 107 is a sinusoidal waveform generator circuit.

As can be seen in FIG. 22, EMI energy is distributed on a relative wide frequency band at multiples of the operating frequency, so that peak value energy is averaged. A margin of the homogenized average value line is about 10 dB, and as can be seen in FIG. 22, the EMI average is significantly decreased compared with that in FIG. 21.

At the same time, to some extent, the peak value line also has improvement according to test result (line \textcircled{1} is a peak value line, and line \textcircled{2} is an average value line).

The FIG. 21 and FIG. 22 are only illustrated for the continuous interfering signal's effect on EMI based on one kind of detail topology of VF converter, should not be used to limit the scope of this application.

Arranging the adjusting unit in other position in the control stage circuit of the variable frequency signal stage circuit module may similarly realize the frequency jitter function, but it is not limited to the above embodiments.

### Embodiment 5

In addition to directly changing magnitude of a detection signal or a feedback signal, the magnitude of the detection signal may be also indirectly changed by controlling resistance of a detecting resistor, so as to change an operating frequency of the VF converter, referring to FIG. 23.

The variable frequency signal stage circuit module 202 comprises a detection stage circuit and a control stage circuit, the detection stage circuit comprises an input detection stage circuit and an output detection stage circuit, an adjusting unit 106 and the input detection stage circuits are electrically connected.

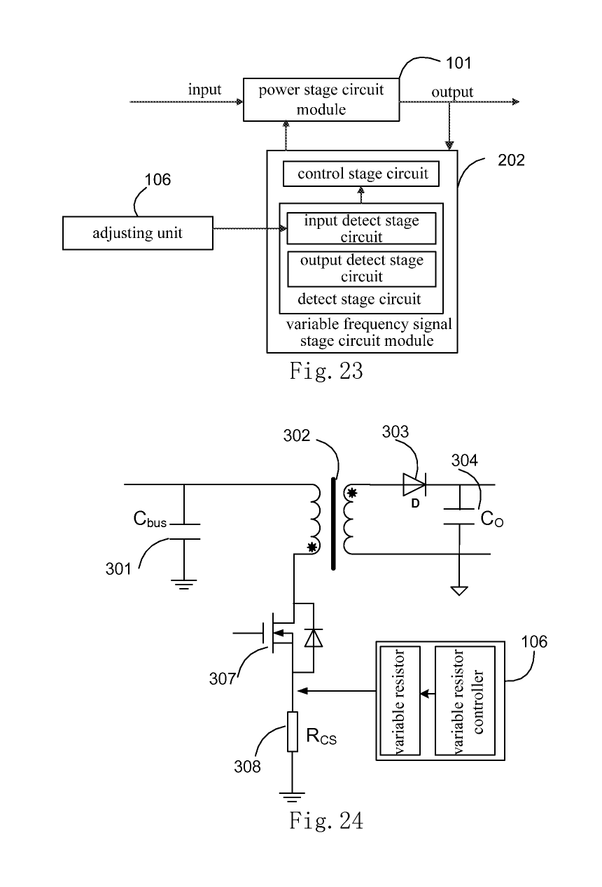

For more detail, please refer to FIG. 24, FIG. 25, and FIG. 26.

A detecting resistor R_{cs} 308 belongs to the input detection stage circuit; the adjusting unit 106 and the detecting resistor R_{cs} 308 are electrically connected. The adjusting unit 106 comprises an adjusting element and an adjusting element controller matched with the adjusting element. The adjusting element 106 may be a variable resistor and a corresponding variable resistor controller, the resistance of the variable resistor changes with time under control of the variable resistor controller matched with the variable resistor, so as to realize that a continuous interfering signal is loaded into the input stage detection circuit.

Specifically, the variable resistor is a variable resistor Rt, the detecting resistor R_{cs} 308 is in series or in parallel connected to the variable resistor Rt, a connection in parallel is shown in FIG. 25. The resistor Rt receives a control signal from the variable resistor controller. Due to the resistance of variable resistor Rt changes with time, peak value current passing through the detecting resistor R_{cs} 308 changes, i.e, a detection signal change outputted by the input detection stage circuit, and the operating frequency of the VF converter changes.

More specifically, as shown in FIG. 26, the variable resistor Rt is implemented by a transistor 309 operating in a line region, a variable resistor controller 310 is a circuit module capable of outputting a variable voltage, the circuit module may output a voltage signal which changes periodically or non-periodically, the voltage signal may be a sinusoidal waveform, a triangular waveform, a rectangular waveform, a trapezoidal waveform and a superimposed waveform, and so on. However, changing a voltage applied to the base of the transistor may allow the transistor has different impedance. By changing the variable voltage signal outputted by the variable resistor controller, the impedance of the transistor may be controlled to change continuously. And the impedance of the transistor 309 connected in parallel to the detecting resistor R_{cs} 308 changes continuously, i.e. may cause the sampling current signal in the detecting resistor R_{cs} 308 to change continuously.

In the flyback topology, peak value of primary side current passing through the power switch is relevant to the turn-on time of the switch, the peak value is higher, the turn-on time of the switch is longer, and the turn-on time is relevant to the operating frequency of the VF converter.

In the short time of several switching cycles of the switch, it is considered that voltage sampling signal Vcs at two terminals of the detecting resistor Rcs is constant, wherein Vcs=Ipeak*Rcs, Ipeak is the peak value current passing through the detecting resistor Rcs. When the transistor is connected in parallel, if the same Vcs sampling voltage valve is required for the two terminals of the detecting resistor Rcs, a peak value current passing through the detecting resistor Rcs at this time is Ipeak2=Ipeak*RcsRt/(Rcs+Rt). As can be seen from this equation, peak value current Ipeak2 is a variable relevant to Rt, and the peak value current Ipeak2 changes as Rt changes.

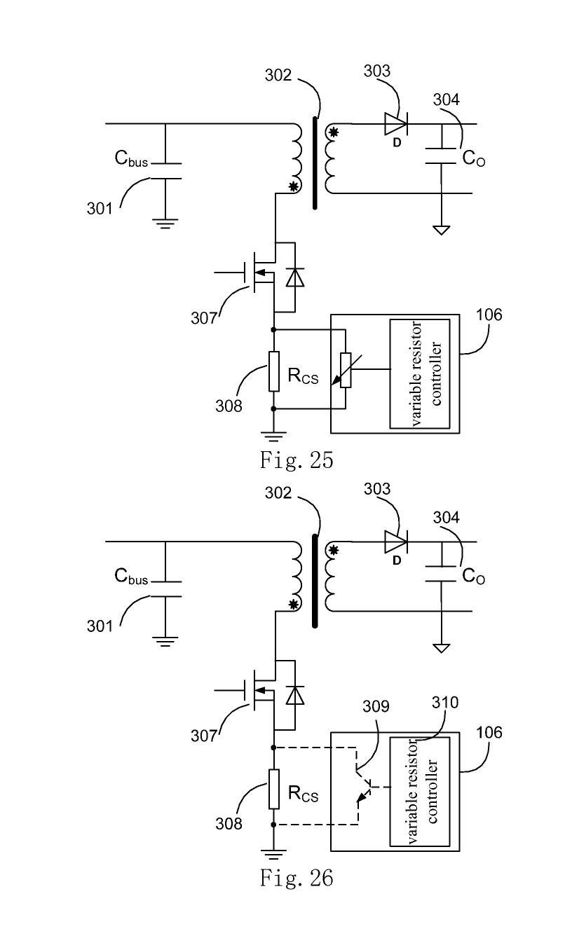

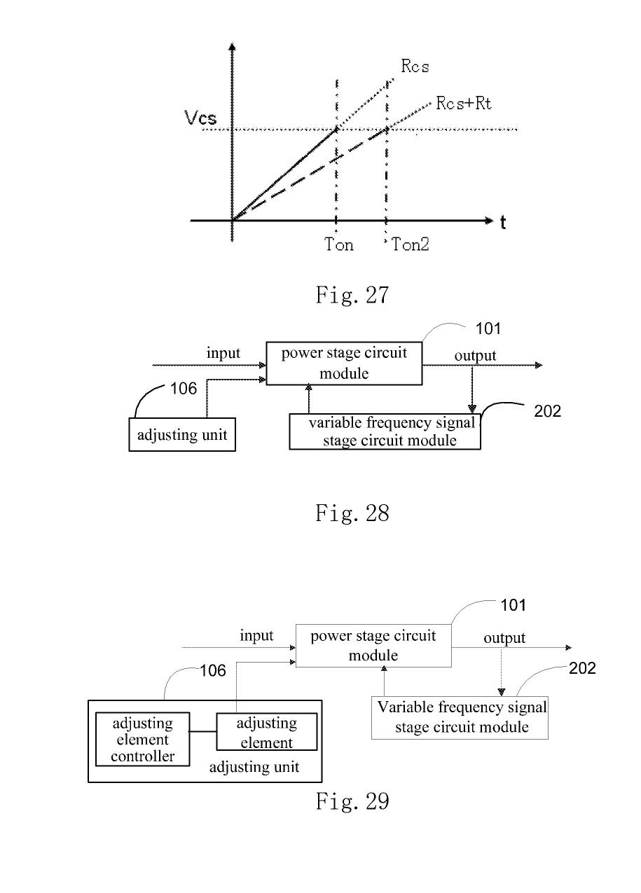

According to this embodiment disclosed here, the conclusion that the peak value current is higher and the turn-on time of the power switch is longer can be obtained. For the same Vcs, the turn-on time Ton2 of the switch in the topology in which the detecting resistor is connected with the variable resistor Rt in parallel is longer than the turn-on time Ton of the switch in the topology in which there is no variable resistor Rt. Referring to FIG. 27, it schematically illustrates an effect of the variable resistor on the turn-on time. Therefore, the above illustrated adjusting units comprising a variable resistor and a matched variable resistor controller, connected to the input detection stage circuit of the variable frequency signal stage circuit module so as to realize that a continuous interfering signal is loaded into the input detection stage circuit. The continuous interfering signal could cause continuous change of the turn-on time of the switch, so that it could realize continuous jitter on the operating frequency of the VF converter. That the frequency of the continuous interfering signal generated by continuous change of the variable resistor with time should be higher than the crossover frequency of the VF converter to overcome the attenuation caused by the equivalent closed loop system of the VF converter.

The continuous jitter on the operating frequency may average EMI energy, or decrease the EMI peak value in the VF converter, and or decrease the volume of the EMI filter or avoid using an EMI filter referred in conventional technology.

Although only five embodiments of the VF converter from the first aspect of the present application are illustrated, the protective scope of the present application is not limited to the above embodiments but defined by the appended claims. For some kind of the VF converters, the crossover frequency may be affected by the load connected to the VF converters; therefore a range of the crossover frequency may be determined according to the range of the load connected to the VF converter. The frequency of the continuous interfering signal generated by the adjusting unit 106 is higher than a maximum crossover frequency in the range of the crossover frequency, namely continuous jitter on the operating frequency thereof may be realized in the range of the load connected to the VF converter. Although the embodiments of the VF converter illustrated from the first aspect of the present application are described by taking a DC-DC type VF converter as an example, the VF converter may also be other type of VF converter, such as AC-DC, DC-AC, or AC-AC.

Hereinafter, a VF converter from a second aspect of the present application will be described in details.

In addition to the above embodiments, employing an adjusting unit so as to change a parameter of a power stage circuit module, especially change the parameter of a resonant element in resonance state, the operating frequency on the VF converter may also change continuously, thereby realizing frequency continuously jitter.

FIG. 28 illustrates a schematic diagram of a VF converter, and the VF converter comprises a power stage circuit module 101 and a variable frequency signal stage circuit module 202 connected to the power stage circuit module 101, then the power stage circuit module 101 and the variable frequency signal stage circuit module 202 could form a closed-loop circuit system. The VF converter further comprises an adjusting unit 106. The adjusting unit 106 is connected to the power stage circuit module 101. The adjusting unit 106 changes resonance parameter of the power stage circuit module so that the operating frequency of the power stage circuit module changes continuously.

More specifically, referring to FIG. 29 illustrating a schematic diagram of the VF converter, the adjusting unit 106 comprises an adjusting element and an adjusting element controller matched with the adjusting element. The adjusting element is connected to the power stage circuit module 101. The adjusting element controller controls parameter of the adjusting element to change with time.

### Embodiment 6

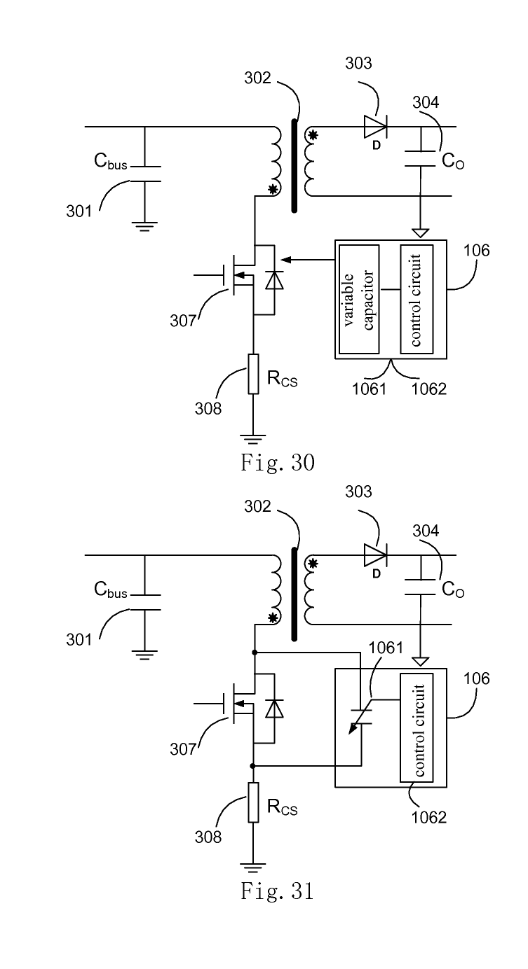

On a basis of FIG. 29, further referring to FIG. 30 and FIG. 31, topology of flyback quasi-resonant controls are illustrated. A power stage circuit module 101 comprises an electrolytic capacitor 301, a transformer 302, a power switch 307, a rectifier diode 303, and an output electrolytic capacitor 304.

Wherein, an adjusting unit 106 is electrically connected to the drain of the power switch 307, the adjusting element is a variable capacitor 1061, and the adjusting element controller is a control circuit 1062. Such a variable capacitor Ct 1061 may be a digital variable capacitor or a solid variable capacitor.

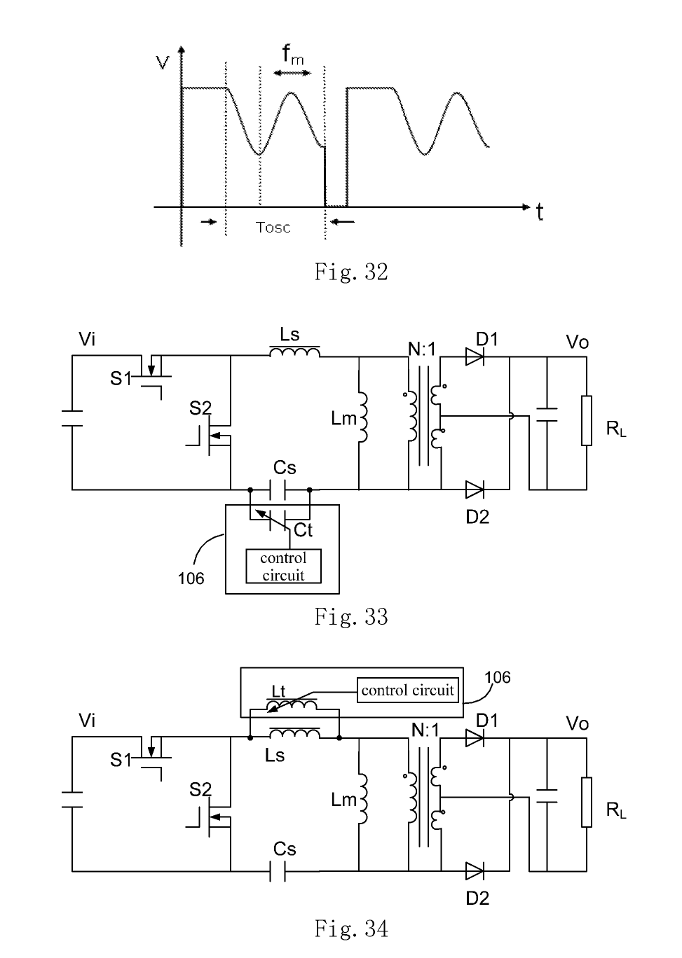

The operation procedure shown in FIG. 31 is as follows. When the power switch 307 is turned off, energy in the transformer 302 is transferred to secondary output side. After transfer is completed, the rectifier diode 303 in the secondary stage is also turned off, the magnetizing inductor of the transformer 302 and the parasitic capacitor of the drain begin to resonate, At this time a drain-source voltage of the power switch 307 is detected, when the drain-source voltage is relatively low, the power switch 307 will be turn on (but is not limited to turn on when the first time the drain-source voltage detected is low, so that turn-on loss of the power switch 307 may be decreased, and conversion efficiency may be improved, at which valley value the power switch 307 turns on will be determined by input voltage and the load). FIG. 32 is a schematic diagram illustrating a waveform of the drain-source voltage of the switch in the flyback quasi-resonant VF converter. FIG. 32 schematically illustrates that the switch is turned on at a second valley.

When the resonance occurs, the resonant frequency fm may be determined by an oscillation between the magnetizing inductor L and a parasitic capacitor Ci of the drain of the power switch 307, i.e. fm=1/T.

T=2π\sqrt{L·Cᵢ} (1)

Wherein T is an operating cycle. Herein, by employing a variable capacitor which capacitance is controllable set at the drain of the switch, the equivalent parasitic capacitor Ci of the power switch may change, so that the whole resonant time Tosc may be changed by changing the resonant frequency fm and finally an on-off cycle may change. An embodiment could be described based on the variable capacitor illustrated in FIG. 31. When the capacitance of the variable capacitor Ct is increased, Ci become larger, as can be seen from the formula (1), Tosc becomes longer, the operating cycle becomes longer, and the operating frequency decrease; when the capacitance of the variable capacitor Ct is decreased, Ci becomes smaller, as can be seen from the formula (1), Tosc becomes shorter, the operating cycle becomes shorter, and the operating frequency increase. If the equivalent capacitance continuously changes, the operating frequency of the VF converter would change continuously, thereby realizing frequency jitter.

### Embodiment 7

On a basis of FIG. 29, further referring to FIG. 33, a schematic diagram of a LLC resonant circuit of the VF converter is illustrated. Wherein, the resonant circuit comprises a resonant capacitor Cs and a resonant inductor Ls which belong to a power stage circuit module.

In series or parallel connection LLC resonant circuit, an on-off frequency varies with the resonant frequency, and the on-off frequency is namely the operating frequency of the VF converter.

The resonant frequency is relevant to resonance parameters of resonant elements in the resonant circuit; therefore, if capacitance of the resonant capacitor Cs is able to change continuously, the resonant frequency may change continuously, so that the operating frequency of the LLC converter may change continuously.

An adjusting element is a variable capacitor Ct connected in parallel with the resonant capacitor Cs, the variable capacitor Ct may be a digital variable capacitor or a solid variable capacitor. An adjusting element controller is a control circuit, the capacitance of the variable capacitor Ct changes with time under the control of the control circuit. As shown in FIG. 33, a series resonant LLC circuit is illustrated; such LLC circuit could only work as a variable frequency converter, and can be distinguished from a constant frequency mode converter by topology of its power stage circuit module. The topology as shown in FIG. 33 is different from the PWM control flyback converter, the PWM control boost converter, the PWM control buck converter in other embodiments of the present application, and is a kind of PFM control VF converter. An operating procedure of the series resonant LLC circuit shown in FIG. 33 will be described as follows. When the capacitance of the variable capacitor Ct is increased, the resonant frequency of the resonant circuit is decreased, the operating frequency of the VF converter is correspondingly decreased; on the contrary, when the capacitance of the variable capacitor Ct is decreased, the resonant frequency is increased, an on-off frequency of the VF converter is also increased. Therefore, by continuously changing the capacitance of the resonant capacitor Cs by the variable capacitor Ct, it is possible to cause the on-off frequency of the VF converter to change continuously, thereby realizing frequency jitter.

### Embodiment 8

The following will disclose another embodiment, in addition to embodiment disclosed above. Continuously changing inductance of a resonant inductor Ls could also reach the purpose of changing the resonant frequency, so as to change the on-off frequency of the VF converter and realize frequency jitter. As shown in FIG. 34, the schematic diagram of a LLC resonant circuit of the VF converter is illustrated. Such LLC circuit could only work as a VF converter, and can be distinguished from a constant frequency mode converter by topology of its power stage circuit module. The topology as shown in FIG. 33 is different from the PWM control flyback converter, the PWM control boost converter, the PWM control buck converter in other embodiments of the present application, and is a kind of PFM control VF converter.

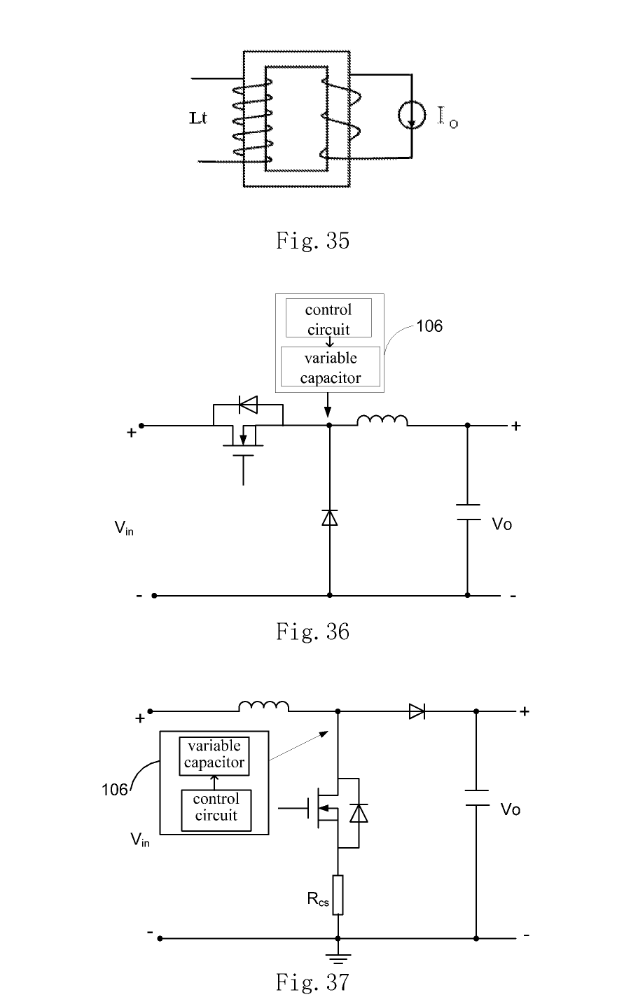

In the present embodiment, an adjusting element is a variable inductor Lt connected in parallel with a resonant inductance Ls. An adjusting element controller is a control circuit, an inductance of the variable inductor Lt changes with time under the control of the control circuit. As shown in FIG. 35, the schematic diagram of the adjusting unit is illustrated. A current source Io is used as the control circuit. The inductance of the variable inductor Lt is determined by magnetic flux through the magnetic core, the current source Io continuously changes the current in the winding so as to change the magnetic flux through the magnetic core, thereby changing the inductance of the variable inductor Lt. The change in the inductance of the variable inductor Lt causes the resonant frequency to be changed, the operating frequency of the VF converter correspondingly changes. As the resonant frequency is increased, the on-off frequency of the VF converter is correspondingly increased; as the resonant frequency is decreased, the on-off frequency of the VF converter is correspondingly decreased. Due to the continuous change in the inductance of the variable inductor Lt, the operating frequency of the LLC converter finally changes continuously, thereby realizing continuous jitter.

### Embodiment 9

An adjusting element may comprise a combination of a variable capacitor and a variable inductor. An adjusting element controller controls the parameter of the variable capacitor and the variable inductor to change with time.

For example, the variable inductor Lt and corresponding control circuit thereof as shown in FIG. 34 may be added to the circuit of FIG. 33.

### Embodiment 10

The method to change parameters of the resonant elements in the power stage circuit module is also applicable to a quasi-resonant buck or boost VF converter, as shown in FIG. 36 and FIG. 37, in which switching frequency of the switch varies with the resonant frequency.

The present application may further comprise many other various embodiments in addition to above embodiments. For example, the adjusting unit 106 could set in both the power stage circuit module and the variable frequency signal stage circuit module, so as to realize a VF converter with frequency jitter while input and output keep stable.

The third aspect of the present application discloses an adjusting method for a VF converter, and the adjusting method is as follows.

The VF converter comprises a power stage circuit module and a variable frequency signal stage circuit module. The variable frequency signal stage circuit module and the power stage circuit module are connected to form a closed-loop circuit system. The adjusting method comprises: setting an adjusting unit in the VF converter, loading a continuous interfering signal into signal inputted to the power stage circuit module by the variable frequency signal stage circuit module through the adjusting unit, so as to cause output of the VF converter to jitter in pre-set range and expand operating frequency range of the VF converter. The frequency of the continuous interfering signal is higher than a crossover frequency of the closed-loop circuit system, thereby realizing expansion of the operating frequency range of VF converter. The continuous interfering signal is a voltage waveform or a current waveform whose amplitude could be constant or variable, and the continuous interfering signal could be periodic or non-periodic. Wherein, the adjusting unit could be a jitter signal generator and inputs the continuous interfering signal generated by the jitter signal generator to the variable frequency signal stage circuit module, so as to realize adjusting the signal inputted to the power stage circuit module by the variable frequency signal stage circuit module. The variable frequency signal stage circuit module comprises an input detection stage circuit and a control stage circuit, the input detection stage circuit outputs a signal to the control stage circuit, the adjusting unit may use an adjusting element and a matched adjusting element controller, the adjusting element is connected to the input detection stage circuit, parameters of the adjusting element is controlled to change with time under the control of the adjusting element controller so as to load the continuous interfering signal into the signal of input detection stage circuit transferred to the control stage circuit.

These control methods may be applied in a variety of VF converters which operate in boundary current mode, or discontinuous current mode, and so on, but not limited to those.

The present application may decrease EMI in the VF converter, and decrease the volume of EMI filter or avoid using an EMI filter. In the VF converter, a continuous jitter on the operating frequency is realized so as to average EMI energy, reduce EMI peak value.

The person skilled in the art may also make various modifications without departing from the spirit and scope of the present application defined by the appending claims. Therefore the present application is not only limited to the disclosure as the above, but defined by the scope of the appending claims.

What is claimed is:

1. A variable frequency converter operating in a variable frequency mode, comprising:
a power stage circuit module and a variable frequency signal stage circuit module which are connected with each other to form a closed-loop circuit system; wherein the variable frequency converter further comprises an adjusting unit outputting a continuous interfering signal and loading the continuous interfering signal into the variable frequency signal stage circuit module so as to cause an operating frequency of the power stage circuit module controlled by the variable frequency signal stage circuit module to change continuously.

2. The variable frequency converter according to claim 1, wherein the adjusting unit is a jitter signal generator outputting the continuous interfering signal to the variable frequency signal stage circuit module.

3. The variable frequency converter according to claim 2, wherein the variable frequency signal stage circuit module comprises a detection stage circuit detecting the power stage circuit module, and a control stage circuit receiving a signal outputted by the detection stage circuit and outputting a signal to the power stage circuit module, the signal outputted by the jitter signal generator is loaded into the detection stage circuit.

4. The variable frequency converter according to claim 3, wherein the detection stage circuit comprises an input detection stage circuit and an output detection stage circuit, the signal outputted by the jitter signal generator is loaded into the input detection stage circuit so as to cause the output signal of the input detection stage circuit or the signal of the input detection stage circuit transferred to the control stage circuit to jitter continuously.

5. The variable frequency converter according to claim 3, wherein the detection stage circuit comprises an input detection stage circuit and an output detection stage circuit, the signal outputted by the jitter signal generator is loaded into the output detection stage circuit so as to cause the output signal of the output detection stage circuit or the signal of the output detection stage circuit transferred to the control stage circuit to jitter continuously.

6. The variable frequency converter according to claim 2, wherein the variable frequency signal stage circuit module comprises a detection stage circuit and a control stage circuit, the detection stage circuit detects the power stage circuit module and outputs a signal to the control stage circuit, the control stage circuit outputs a signal to the power stage circuit module, the signal outputted by the jitter signal generator is loaded into the control stage circuit so as to cause the output signal of the control stage circuit or the signal of the control stage circuit transferred to the power stage circuit module to jitter continuously.

7. The variable frequency converter according to claim 6, wherein the control stage circuit comprises a feedback control circuit and a driving apparatus, the feedback control circuit receives the signal outputted by the detection stage circuit and outputs a signal to the driving apparatus, the signal outputted by the jitter signal generator is loaded into the output signal of the feedback control circuit.

8. The variable frequency converter according to claim 1, wherein the variable frequency signal stage circuit module comprises a detection stage circuit and a control stage circuit, the detection stage circuit comprises an input detection stage circuit and an output detection stage circuit, the adjusting unit is electrically connected to the input detection stage circuit.

9. The variable frequency converter according to claim 8, wherein the adjusting unit comprises an adjusting element connected to the input detection stage circuit, and an adjusting element controller matched with the adjusting element, the adjusting element controller controls the parameter of the adjusting element to continuously change with time so as to load the continuous interfering signal into the input detection stage circuit.

10. The variable frequency converter according to claim 8, wherein the adjusting element is a variable resistor, the adjusting element controller is a variable resistor controller.

11. The variable frequency converter according to claim 1, wherein a frequency of the continuous interfering signal is higher than a crossover frequency of the closed-loop circuit system.

12. The variable frequency converter according to claim 11, wherein the continuous interfering signal is a voltage waveform or a current waveform which is periodical or non-periodical and whose amplitude is constant or variable.

13. An adjusting method for a variable frequency converter comprising a power stage circuit module and a variable frequency signal stage circuit module which are connected with each other to form a closed-loop circuit system, comprising: setting an adjusting unit in the variable frequency converter, loading a continuous interfering signal generated by the adjusting unit into the output signal of the variable frequency signal stage circuit module and transferring the output signal of the variable frequency signal stage circuit module to the power stage circuit module, so as to cause output of the variable frequency converter to jitter and expand the operating frequency range of the variable frequency converter.

14. The adjusting method according to claim 13, wherein the adjusting unit is a jitter signal generator and loads the continuous interfering signal generated by the jitter signal generator into the variable frequency signal stage circuit module.

15. The adjusting method according to claim 13, wherein the variable frequency signal stage circuit module comprises an input detection stage circuit and a control stage circuit, the input detection stage circuit outputs a signal to the control stage circuit, the adjusting unit comprises an adjusting element connected to the input detection stage circuit, and an adjusting element controller matched with the adjusting element, the parameter of the adjusting element is controlled to continuously change with time under the control of adjusting element controller so as to load the continuous interfering signal into the output signal of the input detection stage circuit or the signal of the input detection stage circuit transferred to the control stage circuit.

16. The adjusting method according to claim 13, wherein a frequency of the continuous interfering signal is higher than a crossover frequency of the closed-loop circuit system.

17. The adjusting method according to claim 16, wherein the continuous interfering signal is a voltage waveform or a current waveform which is periodical or non-periodical and whose amplitude is constant or variable.

18. A variable frequency converter comprising a power stage circuit module and a variable frequency signal stage circuit module which are connected with each other to form a closed-loop circuit system, further comprising an adjusting unit connected to the power stage circuit module, the adjusting unit is able to change resonance parameter of the power stage circuit module so as to cause the operating frequency of the power stage circuit module to change continuously.

19. The variable frequency converter according to claim 18, wherein the adjusting unit at least comprises an adjusting element and an adjusting element controller matched with the adjusting element, the adjusting element is connected to the power stage circuit module, the adjusting element controller controls the parameter of the adjusting element to continuously change with time.

20. The variable frequency converter according to claim 19, wherein the adjusting element is a variable capacitor, the variable capacitor is connected to the power stage circuit module, and the adjusting element controller is a variable capacitor controller.

21. The variable frequency converter according to claim 19, wherein the adjusting element is a variable inductor connected to the power stage circuit module, and the adjusting element controller is a variable inductor controller.

22. The variable frequency converter according to claim 19, wherein the adjusting element is a combination of a variable capacitor and a variable inductor, the adjusting element controller controls parameter of the variable capacitor and/or the variable inductor to continuously change with time.
